(19) United States
(12) Patent Application Publication
(10) Pub. No.: US 2017/0111635 A1
(43) Pub. Date: Apr. 20, 2017

(54) IMAGE DISPLAY DEVICE

(71) Applicant: OLYMPUS CORPORATION, Tokyo (JP)

(72) Inventors: Kanto MIYAZAKI, Tokyo (JP); Takeshi YAMAZAKI, Tokyo (JP); Daichi WATANABE, Tokyo (JP)

(73) Assignee: OLYMPUS CORPORATION, Tokyo (JP)

(21) Appl. No.: 15/391,771

(22) Filed: Dec. 27, 2016

Related U.S. Application Data
(63) Continuation of application No. PCT/JP2015/002572, filed on May 21, 2015.

(30) Foreign Application Priority Data
Jul. 11, 2014 (JP) 2014-143424

(51) Int. Cl. H04N 13/04

(52) U.S. Cl. CPC H04N 13/0497; H04N 13/0402; H04N 2213/001

(57) ABSTRACT

Provided is an image display device, including: a light flux emitter (10) which emits a plurality of parallel light fluxes; and a controller (20) which periodically subjects, to two-dimensional deflection, the parallel light fluxes emitted from the light flux emitter (10), based on a scan signal, and controls, synchronously with the scan signal, light intensity of the plurality of parallel light fluxes based on a light intensity control signal based on image information input thereto, in which: the light flux emitter (10) has at least a plurality of photonic crystal semiconductor lasers (11a) which emit the plurality of parallel light fluxes and are two-dimensionally arranged; and the parallel light fluxes emitted from the plurality of photonic crystal semiconductor lasers (11a) are controlled in light intensity, based on the light intensity control signal.

### CROSS REFERENCE TO RELATED APPLICATIONS

The present application is a Continuing Application based on International Application PCT/JP2015/002572 filed on May 21, 2015, which in turn claims priority to Japanese Patent Application No. 2014-143424 filed on Jul. 11, 2014, the entire disclosure of these earlier applications being incorporated herein by reference.

### TECHNICAL FIELD

This disclosure relates to an image display device capable of allowing an observer to observe an image.

### BACKGROUND

JP2013160929A (PTL 1) discloses an image display device that allows for the observation of a virtual image projected at infinity. The image display device converts, by a lens array, a plurality of diffused light fluxes into parallel light fluxes and periodically raster scans the parallel light fluxes by light deflecting elements, and controls, synchronously with the raster scan, the light intensity of light fluxes emitted from the semiconductor laser array, based on image information input thereto. The light fluxes emitted from the light deflecting elements are imaged onto a retina of an observer, to thereby allow the observer to observe a virtual image projected at infinity.

The image display device disclosed in PTL 1 includes a semiconductor laser array and a lens array both being constituted of minute optical elements, to thereby reduce the optical distance between the optical elements, which is advantageous in reducing the thickness of the image display device. Further, the use of the semiconductor laser array and the lens array is also advantageous as it can expand the observable range with a simple configuration.

### CITATION LIST

### Patent Literature

PTL 1: JP2013160929A

### SUMMARY

The disclosed image display device, includes:

a light flux emitter which emits a plurality of parallel light fluxes; and

a controller which periodically subjects, to two-dimensional deflection, the plurality of parallel light fluxes emitted from the light flux emitter, based on a scan signal, and controls, synchronously with the scan signal, light intensity of the plurality of parallel light fluxes based on a light intensity control signal based on image information input thereto,

in which: the light flux emitter has at least a plurality of photonic crystal semiconductor lasers which are two-dimensionally arranged and emit the plurality of parallel light fluxes; and

the parallel light fluxes emitted from each of the plurality of photonic crystal semiconductor lasers are controlled in light intensity, based on the light intensity control signal.

In the disclosed image display device,

the light flux emitter further includes a light flux deflector which subjects, to the two-dimensional deflection, the plurality of parallel light fluxes emitted from the plurality of photonic crystal semiconductor lasers, based on the scan signal.

In the image display device,

the plurality of photonic crystal semiconductor lasers each deflect, based on the scan signal, the parallel light fluxes emitted therefrom, in a first direction of the two-dimensional deflection; and

the light flux emitter further includes a light flux deflector which deflects, based on the scan signal, the plurality of parallel light fluxes emitted from the plurality of photonic crystal semiconductor lasers, in a second direction of the two-dimensional deflection.

In the image display device,

the plurality of photonic crystal semiconductor lasers are two-dimensionally arranged in a direction that coincides with that of the two-dimensional deflection of the plurality of parallel light fluxes; and

the number of the plurality of the photonic crystal semiconductor lasers arranged in the first direction is larger than that of the plurality of photonic crystal semiconductor lasers arranged in the second direction.

In the image display device,

the plurality of photonic crystal semiconductor lasers each subject, to two-dimensional deflection, the parallel light fluxes emitted therefrom, based on the scan signal.

In the image display device,

the plurality of photonic crystal semiconductor lasers includes: a photonic crystal semiconductor laser which emits red light; a photonic crystal semiconductor laser which emits green light; and a photonic crystal semiconductor laser which emits blue light, the photonic crystal semiconductor lasers being regularly arranged.

### BRIEF DESCRIPTION OF THE DRAWINGS

In the accompanying drawings:

FIG. 1 is a schematic illustration of the disclosed image display device according to Embodiment 1;

FIG. 2 illustrates another aspect of use of the image display device of FIG. 1;

FIG. 3 illustrates a schematic configuration of the light flux emitter of FIG. 1;

FIG. 4 is a partial plan view of the photonic crystal semiconductor laser array of FIG. 3;

FIG. 5A is for illustrating an operation of the light flux emitter of FIG. 3 for deflecting light flux in the x-direction;

FIG. 5B is for illustrating an operation of the light flux emitter of FIG. 3 for deflecting light flux in the y-direction;

FIG. 6A shows an example of an image for illustrating the display principle of the image display device of FIG. 1;

FIG. 6B is for illustrating the principle of displaying the image of FIG. 6A;

FIG. 7 illustrates a schematic configuration of the disclosed image display device of Embodiment 2;

FIG. 8A is for illustrating an operation of the light flux emitter of FIG. 7 for deflecting light flux in the x-direction;

FIG. 8B is for illustrating an operation of the light flux emitter of FIG. 7 for deflecting light flux in the y-direction;

FIG. 9A is an enlarged plan view for illustrating an example of the photonic crystal semiconductor laser of FIG. 7;

FIG. 9B is a partial sectional view of the photonic crystal semiconductor laser of FIG. 7;

FIG. 9C shows exemplary periods of holes of the photonic crystal semiconductor laser of FIG. 7;

FIG. 10 illustrates a schematic configuration of the disclosed image display device of Embodiment 3;

FIG. 11A is an enlarged perspective view for illustrating an example of the photonic crystal semiconductor laser of FIG. 10;

FIG. 11B shows an exemplary period of holes in the x-direction of the photonic crystal semiconductor laser of FIG. 10;

FIG. 11C shows an exemplary period of holes in the y-direction of the photonic crystal semiconductor laser of FIG. 10;

FIG. 12 shows periods of two types of holes in the photonic crystal layer of FIGS. 11;

FIG. 13A is for illustrating an operation of deflecting light flux in the x-direction by the photonic crystal semiconductor laser array of FIG. 10;

FIG. 13B is for illustrating an operation of deflecting light flux in the y-direction by the photonic crystal semiconductor laser array of FIG. 10; and

FIG. 14 illustrates a schematic configuration of an essential part of the disclosed image display device of Embodiment 4.

### DETAILED DESCRIPTION

Hereinafter, embodiments the disclosed device are described with reference to the drawings.

### Embodiment 1

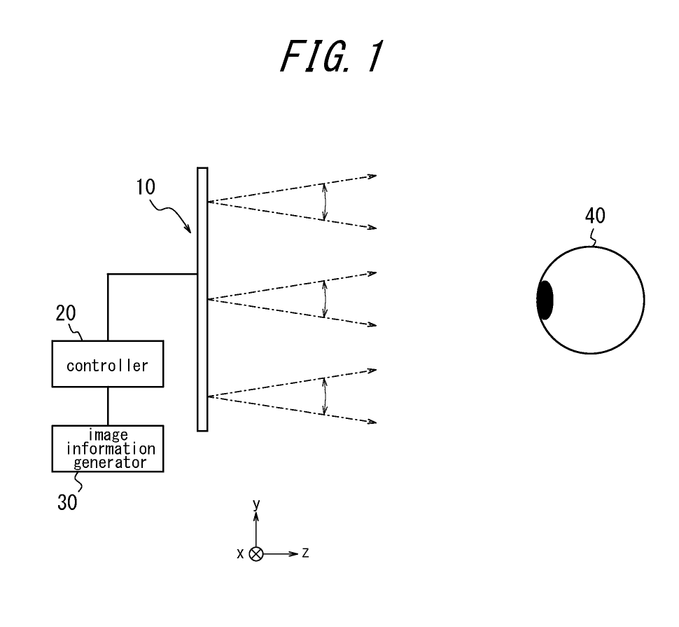

FIG. 1 is a schematic illustration of the disclosed image display device according to Embodiment 1. The image display device includes: a light flux emitter 10; a controller 20; and an image information generator 30. The light flux emitter 10 emits a plurality of parallel light fluxes from a plane observed by an observer 40. The term parallel light fluxes herein may refer to parallel light fluxes that can be deemed substantially parallel, and includes, for example, light fluxes having a spread angle or a restriction angle of the order of 1° or less. FIG. 1 illustrates the x-axis and the y-axis which define, as an xy-plane, the plane observed by the observer 40, and the z-axis orthogonal to the xy-plane. The light flux emitter 10 is configured controllable by the controller 20 which controls the deflection and the light intensity of the plurality of parallel light fluxes to be emitted from the light flux emitter 10. The detailed configuration of the light flux emitter 10 is described later.

The controller 20 periodically subjects the plurality of parallel light fluxes emitted from the light flux emitter 10 to two-dimensional deflection in the xy-plane, based on a scan signal. The two-dimensional deflection scan system may employ an arbitrary system including raster scan and spiral scan as long as being in the xy-plane. In this Embodiment, raster scan is performed in the x- and y-directions. The controller 20 controls the light intensity of the plurality of parallel light fluxes emitted from the light flux emitter 10, based on a light intensity control signal input from the image information generator 3( )and synchronously with the scan signal.

The image information generator 30 is configured by including, for example, a frame memory storing image information on still images and moving images. The image information may be, for example, obtained via a network or the like, or may be obtained from portable recording media.

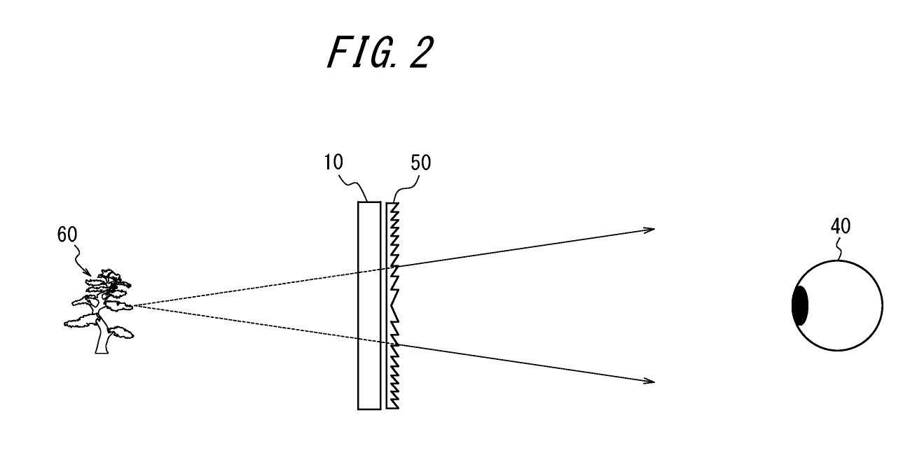

Some of the light fluxes emitted from the light flux emitter 10 across a wide area are imaged onto a retina of the observer 40, which allows the observer 40 to observe a virtual image projected at infinity. Further, as illustrated in FIG. 2, a diopter adjusting member 50 such as, for example, a Fresnel lens may be disposed in front of the light flux emitter 10 as necessary so as to adjust the diopter when observing a virtual image 60.

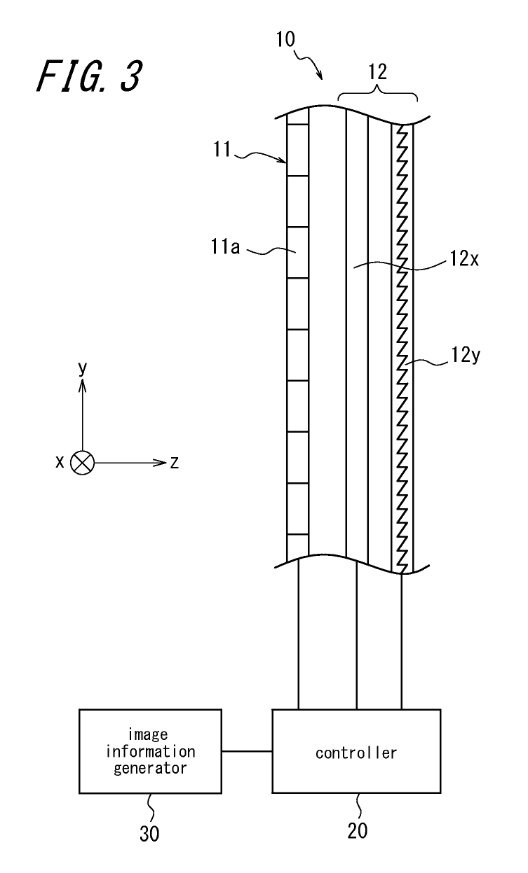

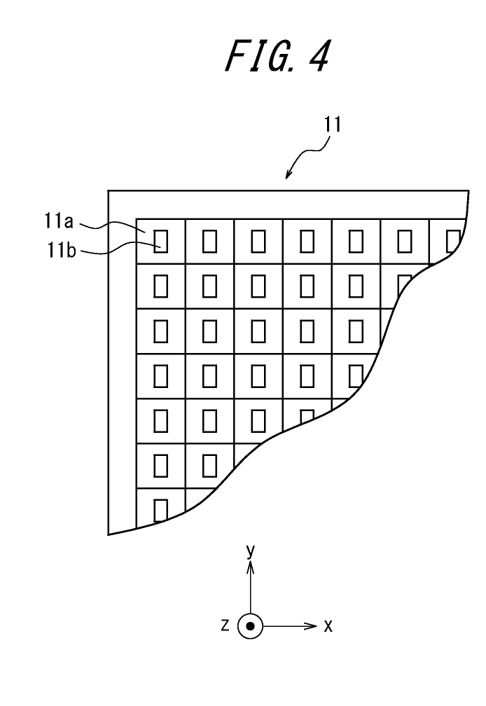

FIG. 3 illustrates a schematic configuration of the light flux emitter 10 of FIG. 1. The light flux emitter 10 includes a photonic crystal semiconductor laser array 11 and a light flux deflector 12. The photonic crystal semiconductor laser array 11 is configured by including, as illustrated in a partial plan view of FIG. 4 viewed from the observer side, a plurality of surface-emitting photonic crystal semiconductor lasers 11a arranged in the x- and y-directions each corresponding to the directions of raster scan by the controller 20. The photonic crystal semiconductor lasers 11a are each controlled by the controller 20 based on light intensity control signals, and emit parallel light fluxes of the same light intensity from an emitting region 11b in the z-direction. The photonic crystal semiconductor laser array 11 viewed in the z-direction is rectangular in outer shape, in which the number of the photonic crystal semiconductor lasers 11a in the x-direction is larger than that in the y-direction.

The light flux deflector 12 includes a light deflecting element 12x and a light deflecting element 12y each deflecting, in the x-direction and in the y-direction, respectively, parallel light fluxes emitted from the photonic crystal semiconductor laser array 11. The light deflecting elements 12x and 12y may be formed of any publicly-known deflecting element such as, for example, a light deflecting element using a crystal microprism (see, for example. JP3273583A) or a light deflecting element using a metamaterial element (see, for example, JP2011112942A).

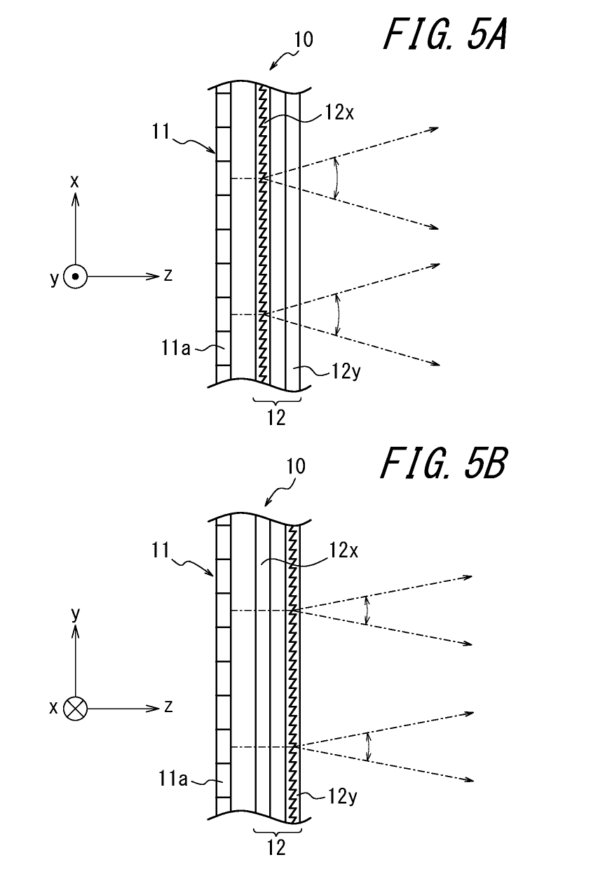

The light deflecting element 12x is controlled by the controller 20 based on a scan signal in the x-direction, and deflects parallel light fluxes emitted from the photonic crystal semiconductor laser array 11, in the x-direction as illustrated in FIG. 5A. The light deflecting element 12y is controlled by the controller 20 based on a scan signal in the y-direction, and deflects parallel light fluxes emitted from the photonic crystal semiconductor laser array 11, in the y-direction as illustrated in FIG. 5B.

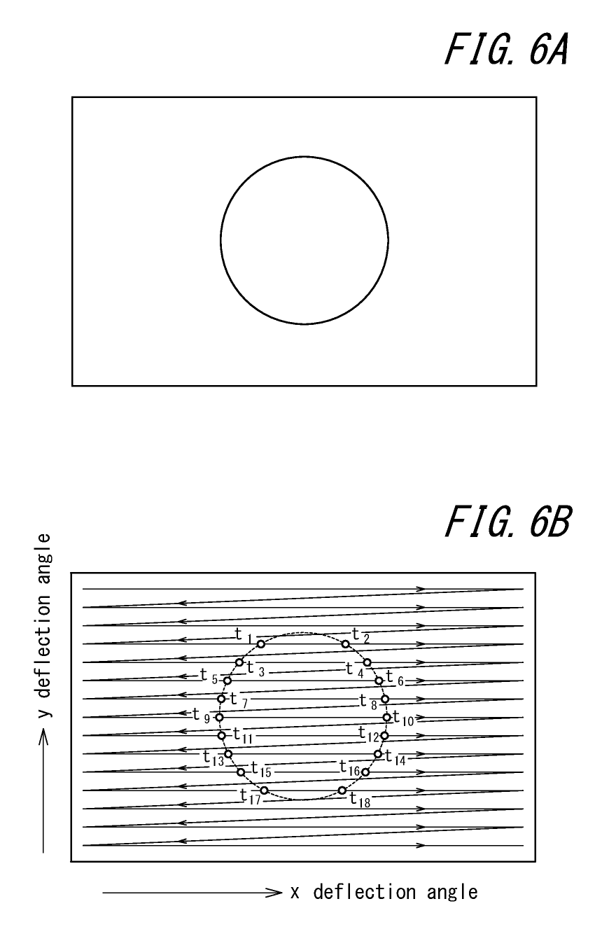

FIGS. 6A and 6B are for illustrating a display principle of the image display device of Embodiment 1. FIG. 6A shows image information to be input to the controller 20. Referring to FIG. 6A, the display principle is explained based on a simplified image having a circle in the center of the screen. FIG. 6B shows how the deflection direction moves in the screen based on a scan signal and on/off of the photonic crystal semiconductor laser array 11. The light deflecting element 12x and the light deflecting element 12y each deflect parallel light fluxes in the x-direction and in the y-direction, respectively, to thereby achieve raster scan as illustrated by the solid line of FIG. 6B,

During the raster scan, the photonic crystal semiconductor laser array 11 may be caused to emit light, synchronously with a scan signal, at times t1 to t18 each corresponding to the contour of the circle of FIG. 6A, to thereby form an image of the circle as illustrated in FIG. 6A. The image thus obtained is formed by parallel light fluxes, which can enlarge the observation range, while allowing the image to be observed as a clear virtual image imaged at infinity when projected onto a retina of the observer 40. Here, the photonic crystal semiconductor laser array 11 may be controlled through, without being limited to the on/off of the light emission, light intensity control signals of multiple stages output from the controller 20 according to the image information, so as to control in multiple stages the intensity of light emitted from the photonic crystal semiconductor laser array 11, to thereby form a multi-gradation image. This way allows for observing an image with light and shade.

According to the disclosed image device of Embodiment 1, the photonic crystal semiconductor laser array 11 is caused to directly emit a plurality of parallel light fluxes, and the parallel light fluxes are raster scanned by the light flux deflector 12, to thereby eliminate the need for a lens array for generating parallel light fluxes. As a result, the device can be made thinner.

Here, the parallel light flux emitted from each of the photonic crystal semiconductor lasers Ha is about 0.5 mm in diameter. The wavelength of the parallel light flux is in the vicinity of 650 nm. The photonic crystal semiconductor lasers 11a are arranged at pitches of about 1 mm in the x-direction. Accordingly, approximately three parallel light fluxes will be incident through the human pupil as the pupil has a diameter of about 3 mm. In this case, the parallel light fluxes, each having a diameter of about 0.5 mm, increases the resolution of the image to be observed as 5 arcminutes due to the influence of diffraction, which is larger than the resolution of the eye of 1 arcminute, but the resolution of 5 arcminutes is sufficient enough to read text or characters.

Exemplified below is numerical data on the image display device of Embodiment 1.

Dimensions of Light Flux Emitter: 120 mm (x-direction), 50 mm (y-direction)

Distance from the Light Flux Emitter Surface to the Observer's Eye: 20 mm to 250 mm

Field Angle: ±5.7° in the x-direction, ±4.3° in the y-direction

### Embodiment 2

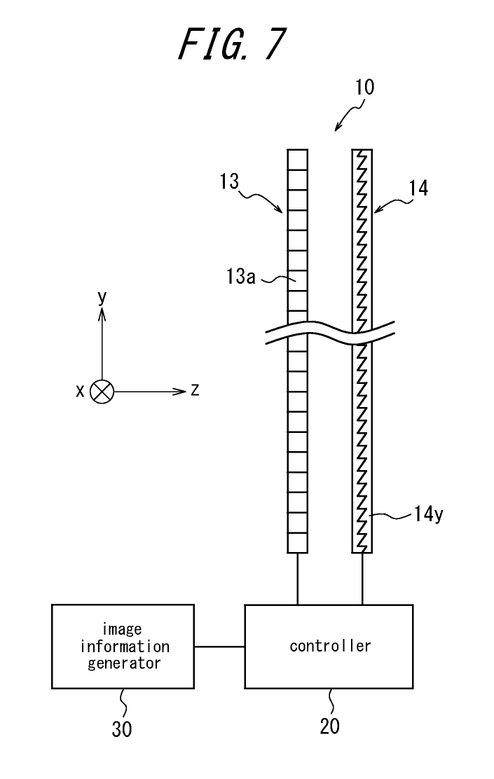

FIG. 7 illustrates a schematic configuration of the disclosed image display device of Embodiment 2. The image display device of Embodiment 2 is different in configuration of the light flux emitter 10, from the image display device of Embodiment 1. In below, differences from Embodiment 1 are described.

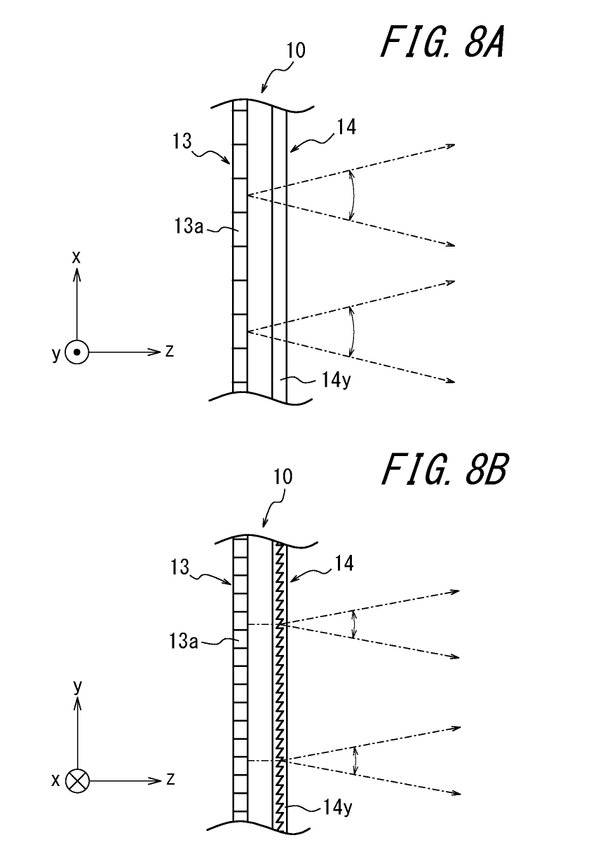

The light flux emitter 10 includes a photonic crystal semiconductor laser array 13 and a light flux deflector 14. The photonic crystal semiconductor laser array 13 includes a plurality of surface-emitting photonic crystal semiconductor lasers 13a which are disposed in a group in each of the x- and y-directions of raster scan, similarly to Embodiment 1. As illustrated in FIG. 8A, the controller 20 controls each of the photonic crystal semiconductor lasers 13a, in terms of the deflection in the x-direction and the light intensity of parallel light fluxes to be emitted therefrom, based on a scan signal in the x-direction and a light intensity control signal that is synchronous with the scan signal, respectively.

As illustrated in FIG. 8B, the light flux deflector 14 includes a light deflecting element 14y controlled by the controller 20, based on a scan signal in the y-direction, in terms of the deflection in the y-direction of parallel light fluxes emitted from the photonic crystal semiconductor laser array 13. The light deflecting element 14y is configured similarly to the light deflecting element 12y explained in Embodiment 1.

In other words, the image display device of Embodiment 2 is different from the image display device of Embodiment 1 in that the photonic crystal semiconductor lasers 11a constituting the photonic crystal semiconductor laser array 11 each have a light flux deflection function for deflecting, one-dimensionally in the x-direction, parallel light fluxes to be emitted, along with which the light deflecting elements 12x are omitted from the light flux deflector 12.

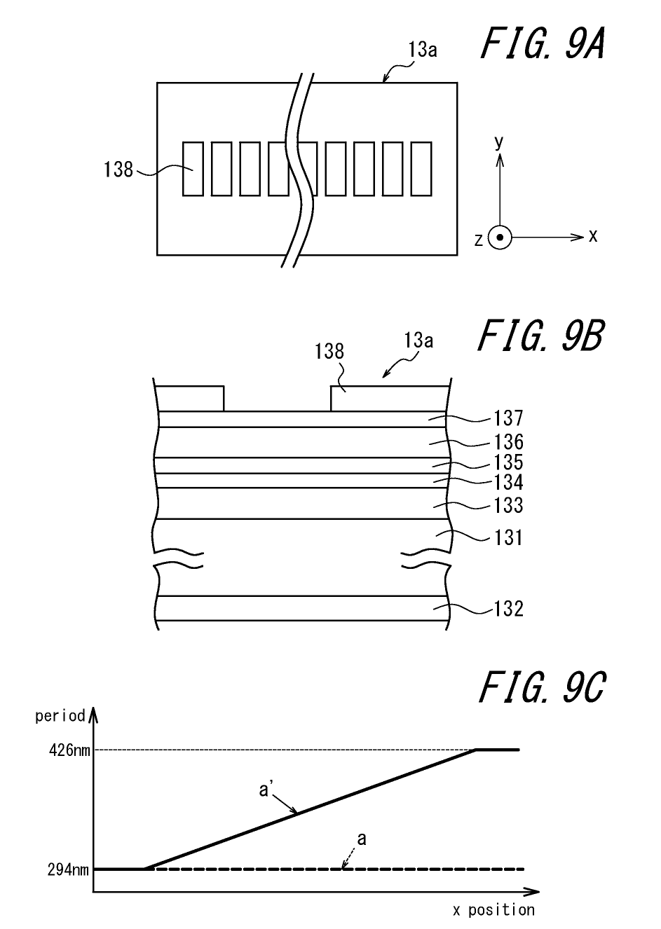

FIGS. 9A, 9B, and 9C are for illustrating an example of the photonic crystal semiconductor laser 13a, in which FIG. 9A is an enlarged plan view, FIG. 9B is a sectional view, and FIG. 9C shows an exemplary period of holes of the photonic crystal, of the photonic crystal semiconductor laser 13a, respectively. Examples of photonic crystal semiconductor lasers having one-dimensional light flux deflection function are disclosed in, for example, JP2013211542 A or http://www.jst.go.jp/pr/announce/20100503/. The photonic crystal semiconductor laser 13a has a lower substrate 131 as illustrated in FIG. 9B. The lower substrate 131 has a back electrode 132 formed on the back side thereof. The lower substrate 131 includes, on the surface side thereof, a first clad layer 133, an active layer 134, a photonic crystal layer 135, a second clad layer 136, an upper substrate 137, and a transparent selection driving electrode 138, which are sequentially formed. The active layer 134 and the photonic crystal layer 135 may be laminated in reverse order.

The selection driving electrodes 138 are disposed in a group and arranged side by side in the x-direction at predetermined intervals, as illustrated in FIG. 9A. The photonic crystal layer 135 is formed of, for example, a silicon thin film combined with photonic crystals having holes with two different periods (grating constants) of a and a′ in the x-direction. As illustrated in FIG. 9C, one of the photonic crystal periods (period a) is fixed to, for example, 294 nm, while the other photonic crystal period (period a′) continuously varies from 294 nm to, for example, 426 nm across the arrangement range of the selection driving electrodes 138 in the x-direction.

In Embodiment 2, the photonic crystal semiconductor laser 13a may be controlled by the controller 20, which controls, based on a scan signal in the x-direction, the balance of current flowing through several electrodes adjacent to each other which are simultaneously driven, of the plurality of the selection driving electrodes 138, so as to drive each of the electrodes sequentially in the x-direction, to thereby deflect, in the x-direction, the parallel light fluxes to be emitted. Further, the photonic crystal semiconductor laser 13a may be controlled in intensity of parallel light fluxes to be emitted, by controlling the entire current to flow through the selection driving electrodes 138 which are simultaneously driven.

Here, the diameter and wavelength of parallel light fluxes to be emitted from the photonic crystal semiconductor lasers 13a and intervals of adjacent photonic crystal semiconductor lasers 13a along the x-direction are similar to those of Embodiment 1. Further, the exemplary numeric data of mage display device is similar to that of Embodiment 1.

According to the image display device of Embodiment 1, the photonic crystal semiconductor laser array 13 has a light flux deflection function for deflecting, one-dimensionally in the x-direction, parallel light fluxes to be emitted, which eliminates the need for the light deflecting element 12x of Embodiment 1. Accordingly, the device can be made further thinner as compared with that of Embodiment 1. Further, the photonic crystal semiconductor laser array 13 deflects light fluxes in the x-direction, in which a larger number of the photonic crystal semiconductor lasers 13a are disposed, which allows for high speed scan in the x-direction. Therefore, raster scan can be performed at higher speed, which improves the frame rate of the display image to thereby prevent flickering of the image.

### Embodiment 3

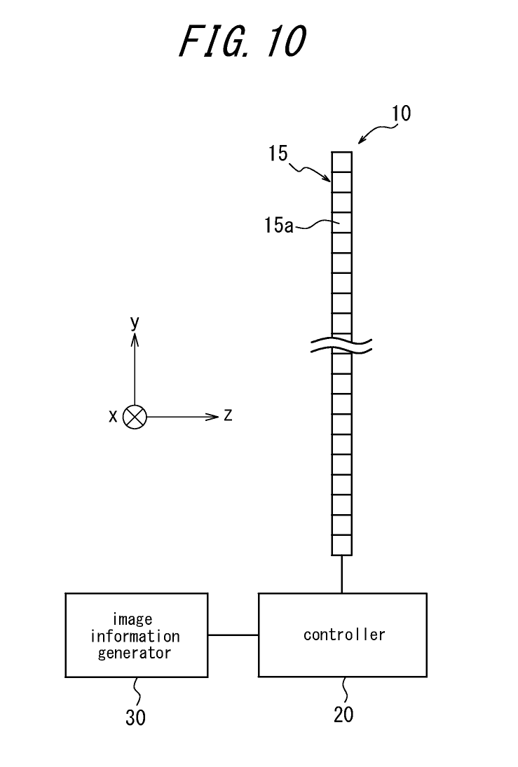

FIG. 10 illustrates a schematic configuration of the disclosed image display device of Embodiment 3. In the image display device of Embodiment 3, the light flux emitter 10 includes a photonic crystal semiconductor laser array 15 having a two-dimensional light flux deflection function. The rest of the configuration is similar to those of Embodiments 1 and 2, and thus differences are described in below.

The photonic crystal semiconductor laser array 15 includes a plurality of photonic crystal semiconductor lasers 15a disposed in a group in each of the x- and y-directions of raster scan, similarly to Embodiments 1 and 2. The controller 20 controls each of the photonic crystal semiconductor lasers 15a, in terms of the deflection in the x- and y-directions and the intensity of parallel light fluxes to be emitted therefrom, based on a scan signal of raster scan and a light intensity control signal synchronous with the scan signal, respectively.

In other words, the image display device of Embodiment 3 is different from the image display device of Embodiment 1 in that the photonic crystal semiconductor lasers 11a forming the photonic crystal semiconductor laser array 11 each have a function of deflecting, two-dimensionally in the x- and y-directions, parallel light fluxes to be emitted, along with which the light flux deflector 12 is omitted.

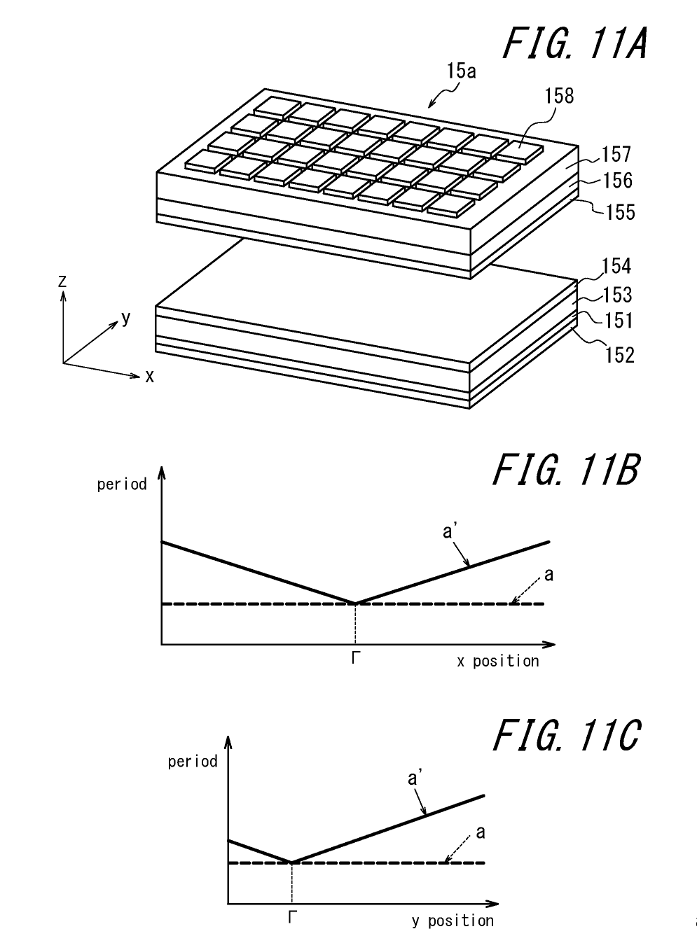

FIGS. 11A, 11B, and 11C are for illustrating an example of the photonic crystal semiconductor laser 15a. The photonic crystal semiconductor laser 15a has a lower substrate 151, as illustrated in an enlarged perspective view of FIG. 11A. The lower substrate 151 has a back electrode 152 formed on the back side thereof. The lower substrate 151 includes, on the surface side thereof, a first clad layer 153, a photonic crystal layer 154, an active layer 155, a second clad layer 156, an upper substrate 157, and a transparent selection driving electrode 158 formed thereon. The photonic crystal layer 154 and the active layer 155 may be laminated in the reverse order. FIG. 11A illustrates the photonic crystal layer 154 and the active layer 155 as separated from each other for convenience.

The selection driving electrodes 158 are disposed in a group and arranged side by side in each of the x- and y-directions at predetermined intervals. FIG. 11A illustrates, by way of example, eight of the selection driving electrodes 158 in the x-direction and four in the y-direction.

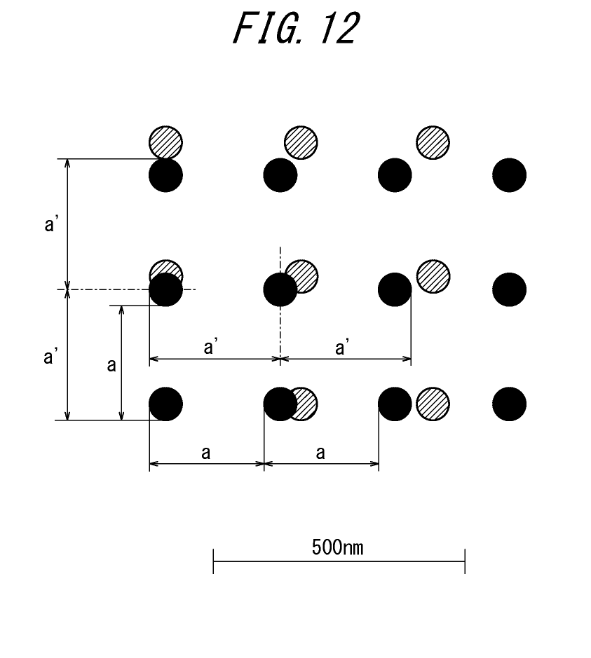

The photonic crystal layer 154 is formed of, as illustrated in FIG. 12 for example, a silicon thin film combined with photonic crystals having holes with two different periods (grating constants) of a and a′ in the x- and y-directions. As illustrated in FIGS. 11B and 11C, the period a is constant in each of the x- and y-directions. The period a′ gradually increases with distance in the x- and y-directions from the in-plane wave zero point (point Γ) as the center.

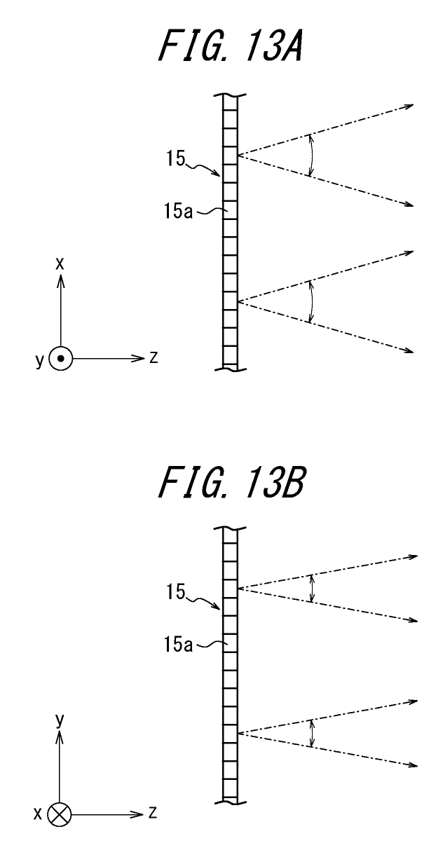

In Embodiment 3, the photonic crystal semiconductor laser 15a may select, from among the plurality of the selection driving electrodes 158, the one for having a current to pass therethrough and the magnitude of the current, to thereby emit parallel light fluxes having a desired intensity from a desired region. At this time, the difference between the periods a and a′ may vary depending on the region, and thus, parallel light fluxes are emitted at different emission angles for each region. That is, parallel light fluxes are emitted in a direction perpendicular to the xy-plane in a region near the point Γ (region where the difference between the periods a and a′ is small), while parallel light fluxes are emitted in a direction inclined relative to the normal direction of the point Γ in a region away from the point Γ. In other words, with distance from the point Γ in the x-direction, parallel light fluxes are emitted as inclined in the x-direction as illustrated in FIG. 13A. Similarly, with distance from the point Γ in the y-direction, parallel light fluxes are emitted as inclined in the y-direction as illustrated in FIG. 13B. With distance from the point Γ in the x- and y-directions, parallel light fluxes are emitted as being inclined relative to both x- and y-directions. This way allows parallel light fluxes emitted from the photonic crystal semiconductor lasers 15a to be raster scanned.

Here, the diameter and wavelength of parallel light fluxes to be emitted from the photonic crystal semiconductor lasers 15a. and intervals of adjacent photonic crystal semiconductor lasers 15a along the x -direction are similar to those of Embodiment 1. Further, the exemplary numeric data of the image display device is similar to that of Embodiment 1.

According to the image display device of Embodiment 3, the photonic crystal semiconductor laser array 15 has a function of two-dimensionally deflecting, in the x- and y-directions, parallel light fluxes to be emitted, which eliminates the need for the light flux deflector 14 of Embodiment 2. Accordingly, the device can be made further thinner as compared with that of Embodiment 2. Further, the photonic crystal semiconductor laser array 15 allows for raster scanning, at high speed, parallel light fluxes to be emitted, which can more reliably prevent flickering of the displayed image.

### Embodiment 4

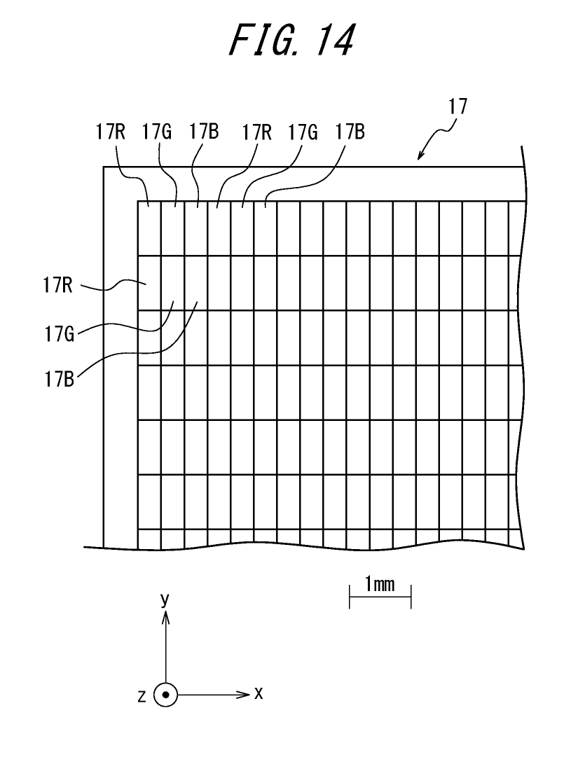

FIG. 14 illustrates a schematic configuration of an essential part of the disclosed image display device of Embodiment 4. In the image display device of Embodiment 4, the light flux emitter 10 includes a photonic crystal semiconductor laser array 17 for displaying a color image. FIG. 14 shows, in a partial plan view, the photonic crystal semiconductor laser array 17.

The photonic crystal semiconductor laser array 17 includes: a photonic crystal semiconductor laser 17R fir surface-emitting parallel light fluxes of red light (R); a photonic crystal semiconductor laser 17G for surface-emitting parallel light fluxes of green light (G); and a photonic crystal semiconductor laser 17B for surface-emitting parallel light fluxes of blue light (B). The photonic crystal semiconductor lasers 17R, 17G, and 17B are regularly arranged in the x-direction of the raster scan, while photonic crystal semiconductor lasers emitting the same color are arranged in the y-direction. Three photonic crystal semiconductor lasers 17R, 17G, and 17B sequentially arranged in the x-direction may have a total dimension of 1 mm or less.

The image display device of Embodiment 4 employs the photonic crystal semiconductor laser array 17 of FIG. 14, in place of the photonic crystal semiconductor laser array of any one of Embodiments 1 to 3 above. Therefore, in the case of providing, for example, the photonic crystal semiconductor laser array 17 with a function of one-dimensionally deflecting light fluxes as in Embodiment 2, the photonic crystal semiconductor lasers 17R, 17G, and 17B each may be configured similarly to the photonic crystal semiconductor laser 13a illustrated with reference to FIGS. 9A to 9C. Further, in the case of providing, for example, the photonic crystal semiconductor laser array 17 with a function of two-dimensionally deflecting light fluxes as in Embodiment 3, the photonic crystal semiconductor lasers 17R, 17G, and 17B each may be configured similarly to the photonic crystal semiconductor laser 15a illustrated with reference to FIGS. 11A to 11C. The photonic crystal semiconductor lasers 17R, 17G, and 17B are controlled in light intensity, based on a light intensity control signal which indicates a color component of a pixel of the display image and is synchronized with a scan signal, so as to emit parallel light fluxes with the same light intensity for each color.

The image display device of Embodiment 4 is capable of observing a color image, in addition to the effects to be obtained by Embodiments described above. In addition, at least three parallel light fluxes of RGB are incident on the pupil of the observer, which causes no color drift in the color image to be observed.

Exemplified below is numeric data of the image display device of Embodiment 4.

Dimensions of Light Flux Emitter: 160 mm (x-direction), 70 mm (y-direction)

Distance from the Light Flux Emitter Surface to the Observer's Eye: 20 mm to 250 mm

Angle of View: x-direction 10′, y-direction 5.6°

The disclosed device is not limited to those of Embodiments above, and may be subjected to various modifications and alterations without departing from the gist of the disclosure.

### REFERENCE SIGNS LIST

10 light flux emitter

11, 13, 15, 17 photonic crystal semiconductor laser array

11a, 13a, 15a, 17R, 17G, 17B photonic crystal semiconductor laser

12, 14 light flux deflector

12x, 12y, 14y light deflecting element

20 controller

1. An image display device, comprising:
a light flux emitter which emits a plurality of parallel light fluxes; and
a controller which periodically subjects, to two-dimensional deflection, the plurality of parallel light fluxes emitted from the light flux emitter, based on a scan signal, and controls, synchronously with the scan signal, light intensity of the plurality of parallel light fluxes based on a light intensity control signal based on image information input thereto,
wherein: the light flux emitter has at least a plurality of photonic crystal semiconductor lasers which are two-dimensionally arranged and emit the plurality of parallel light fluxes; and
the parallel light fluxes emitted from each of the plurality of photonic crystal semiconductor lasers are controlled in light intensity, based on the light intensity control signal.

2. The image display device according to claim 1,
wherein the light flux emitter further includes a light flux deflector which subjects, to the two-dimensional deflection, the plurality of parallel light fluxes emitted from the plurality of photonic crystal semiconductor lasers, based on the scan signal.

3. The image display device according to claim 1,
wherein: the plurality of photonic crystal semiconductor lasers each deflect, based on the scan signal, the parallel light fluxes emitted therefrom, in a first direction of the two-dimensional deflection; and
the light flux emitter further includes a light flux deflector which deflects, based on the scan signal, the plurality of parallel light fluxes emitted from the plurality of photonic crystal semiconductor lasers, in a second direction of the two-dimensional deflection.

4. The image display device according to claim 3,
wherein: the plurality of photonic crystal semiconductor lasers are two-dimensionally arranged in a direction that coincides with that of the two-dimensional deflection of the plurality of parallel light fluxes; and
the number of the plurality of the photonic crystal semiconductor lasers arranged in the first direction is larger than that of the plurality of photonic crystal semiconductor lasers arranged in the second direction.

5. The image display device according to claim 1,
wherein the plurality of photonic crystal semiconductor lasers each subject, to the two-dimensional deflection, the parallel light fluxes emitted therefrom, based on the scan signal.

6. The image display device according to claim 1,
wherein the plurality of photonic crystal semiconductor lasers includes: a photonic crystal semiconductor laser which emits red light; a photonic crystal semiconductor laser which emits green light; and a photonic crystal semiconductor laser which emits blue light, the photonic crystal semiconductor lasers being regularly arranged.
